(19) United States
(12) Patent Application Publication
(10) Pub. No.: US 2024/0336508 A1
(43) Pub. Date: Oct. 10, 2024

(54) METHOD AND SYSTEM FOR RESOURCE TREATMENT OF REVERSE OSMOSIS CONCENTRATED BRINE BY BIPOLAR MEMBRANE ELECTRODIALYSIS

(71) Applicant: Xi'an University of Architecture and Technology, Shaanxi (CN)

(72) Inventors: Xudong WANG, Shaanxi (CN); Haibing TANG, Shaanxi (CN); Bitao XU, Shaanxi (CN); Lei WANG, Shaanxi (CN); Licheng CHEN, Shaanxi (CN); Yongtao LV, Shaanxi (CN)

(21) Appl. No.: 18/631,294

(22) Filed: Apr. 10, 2024

(30) Foreign Application Priority Data
Apr. 10, 2023 (CN) 202310374819.3

(51) Int. Cl. C02F 9/00; B01D 61/02; B01D 61/14; B01D 61/42; B01D 61/44; B01D 61/58; B01D 69/02; B01D 71/02; C02F 1/44; C02F 1/467; C02F 1/469; C02F 1/66; C02F 5/02

(52) U.S. Cl. CPC C02F 9/00; B01D 61/58; B01D 69/02; B01D 71/02; B01D 61/025; B01D 61/147; B01D 61/422; B01D 61/445; B01D 2311/08; B01D 2325/02834; C02F 1/441; C02F 1/444; C02F 1/4672; C02F 1/4695; C02F 1/66; C02F 5/02; C02F 2201/46145

(57) ABSTRACT

Disclosed are a method and system for resource treatment of a reverse osmosis concentrated brine (ROC) by bipolar membrane electrodialysis. The method includes: adding a calcium-magnesium precipitant to ROC, and mixing, to remove hardness; filtering a resulting mixture through diatomaceous earth, to intercept an organic matter and a precipitate; adjusting a resulting filtrate to be acidic with a pH adjuster; feeding a resulting acidic filtrate in an electro-Fenton reaction device, and subjecting the resulting acidic filtrate to oxidation under an acidic environment, such that a chemical oxygen demand removal rate is not less than 97%; subjecting a resulting effluent from the electro-Fenton reaction device to fine filtration with a polypropylene microporous filter, to obtain a fine filtrate; and introducing the fine filtrate into a bipolar membrane electrodialysis device, and performing the bipolar membrane electrodialysis, to generate an acid and an alkali under the action of an external electric field.

### CROSS REFERENCE TO RELATED APPLICATION

This patent application claims the benefit and priority of Chinese Patent Application No. 202310374819.3 filed with the China National Intellectual Property Administration on Apr. 10, 2023, the disclosure of which is incorporated by reference herein in its entirety as part of the present application.

### TECHNICAL FIELD

The present disclosure belongs to the technical field of reverse osmosis concentrated brine (ROC) treatment, and specifically relates to a method and a system for resource treatment of an ROC by bipolar membrane electrodialysis.

### BACKGROUND

With the development of industry in China, industrial water consumption is increasing annually, the discharge of wastewater increases thereupon, with a drainage composition becoming more and more complex. In particular, a large portion of high-salt wastewater is generated in the fields of coal conversion, thermal power plant desulfurization, printing and dyeing, papermaking, as well as extraction and processing of petroleum and natural gas. This is in sharp contrast to the current serious pollution of water resources and the increasingly strict standards for industrial wastewater treatment and reuse in China, and has resulted in an increasingly prominent contradiction between water supply and demand, thus seriously restricting the rapid and healthy development of the national economy. Therefore, high-salt wastewater treatment and resource utilization have become an inevitable choice for environmental protection and sustainable utilization of water resources. A sustainable option for treating high-salt wastewater is the development of “zero emission” waste liquid systems. Early zero-emission systems mainly depend on thermal evaporation technology, and thus show extremely high energy consumption. In order to reduce treatment costs, reverse osmosis technology is widely used in the treatment of high-salt wastewater. The reverse osmosis technology could obtain about 70% of high-quality recycled water from high-salt wastewater, and exhibits desirable environmental and economic benefits. However, this technology also produces about 30% of reverse osmosis concentrated brine (ROC). The ROC has a total dissolved solid (TDS) content of generally 10 g/L to 50 g/L, and mainly contains inorganic cations such as sodium, potassium, calcium, magnesium, and silicon ions, as well as inorganic anions such as chloride, sulfate, and nitrate ions. In addition, heavy metals are contained in the ROC, mainly including arsenic, barium, cadmium, lead, copper, and zinc. As another feature, ROC contains a wide variety of organic matter species, which are difficult to biochemically degrade, thereby showing a high chemical oxygen demand (COD) (200 mg/L to 4,000 mg/L). Direct discharge of ROC without treatment could cause serious pollution to the water environment. As a result, resource treatment of the ROC based on environmental protection requirements and “zero emission” of wastewater has become an important part of current water treatment.

At present, the treatment and disposal technologies for ROC mainly include natural evaporation, thermal evaporation, membrane separation, and direct emission reduction (such as recovery, discharge of surface water or sewage treatment system, and deep well injection). However, conventional ROC treatment or disposal technologies and methods have limitations or shortcomings. Their purpose is mainly to reduce the impact of ROC by reducing the volume or pollution load of ROC, but does not essentially achieve “zero emission” of the ROC. In addition, according to research data, a cost of ROC emissions accounts for approximately 20% to 35% of a total treatment costs, resulting in a waste of water resources and energy consumption.

CN101928088B discloses “a method for treating ROC in petrochemical enterprises.” This method adopts a treatment process of “nanofiltration+alkali adjustment+air flotation magnesium removal+calcium removal+microfiltration+neutralization+reverse osmosis+multi-effect evaporation+drying”; produced water during the treatment can be returned to a reverse osmosis system of the previous level for treatment and reuse; and a residue obtained during the treatment can be collected and disposed together. This method could reduce the pollution of reverse osmosis membrane and improve the treatment efficiency, and has certain social and economic benefits. However, this method still cannot achieve zero emissions, and has high costs and cumbersome procedures during the treatment, resulting in a low efficiency.

CN106396234A discloses “a zero-emission treatment method of ROC”. This method is to conduct nanofiltration on pretreated ROC to obtain nanofiltration concentrate rich in SO₄²⁻ and Mg²⁺ and nanofiltration penetrating liquid containing Na⁺, Cl⁻, NO₃⁻, K⁺, and Ca²⁺. After concentration, the nanofiltration concentrate is mixed with the penetrating liquid to precipitate, thereby removing CaSO₄, and then subjected to further separation by crystallization. the nanofiltration permeate is subjected to processes such as medium-pressure reverse osmosis, multi-effect evaporation, and multi-effect membrane distillation to concentrate such that various inorganic salts contained therein are at a nearly saturated state, and then fresh water resources therein are recovered. This method recovers fresh water and solid salts, and eliminates the pollution of ROC, but adopts evaporation crystallization with high cost, and produces solid miscellaneous salts that are difficult to separate out and may also generate secondary pollution.

CN109081488A discloses “a method and system for resource utilization of industrial concentrated brine”. This method involves mixing industrial concentrated salt water with alkaline solution and removing precipitates through a microfiltration system. After passing through a nanofiltration system, a solution a containing mainly monovalent salts and a solution b containing mainly divalent salts are obtained. The solution a is concentrated by a reverse osmosis system and then evaporated and crystallized to obtain an industrial sodium chloride product, while the solution b is further subjected to resin exchange to remove calcium and magnesium ions and then electrolyzed to obtain an alkali solution and a sulfuric acid solution. This process has an ingenious system design, although recycling the electrolyzed alkaline solution can reduce the dosing cost of the system, obtaining the industrial sodium chloride product through high-energy-consumption evaporation crystallization is not conducive to the long-term economic benefits of enterprises. Even if the quality of the sodium chloride produced could meet the requirements of first-class industrial products, there has been an excessive domestic production of sodium chloride. Accordingly, most of the industrial sodium chloride product produced with zero emissions is sold at ultra-low prices, which is not conducive to practical applications.

The above references could process ROC better and also recover useful resources in the ROC. However, the traditional methods of recycling salt have high energy consumption, large investment, and poor efficiency, while the recycled industrial salt is also difficult to sell. Moreover, these methods involve complex processes, and errors in any link could directly affect the quality of the crystallized salt. In view of this, there is an urgent need to explore an efficient and low-cost resource treatment method.

### SUMMARY

The present disclosure aims to overcome the problems and defects in the existing traditional technology for treating ROC, and provides a method for resource treatment of an ROC by a bipolar membrane electrodialysis device. The present disclosure solves the problems of high treatment cost and great harm of crystallized miscellaneous salts produced by the existing ROC treatment technology, and the recovered acid and alkali in the present disclosure are reused in the pretreatment, or further processed and sold. In the present disclosure, COD is removed from wastewater using an electro-Fenton technology, which could extend a service life of the membrane while reducing the risk of membrane fouling and clogging.

The present disclosure is achieved by the following technical solutions.

On one hand, the present disclosure provides a method for resource treatment of an ROC by bipolar membrane electrodialysis, including the following steps:
(a) adding a calcium-magnesium precipitant to the ROC, and mixing, to remove hardness;
(b) filtering a resulting mixture after removing hardness through diatomaceous earth, which is realized by forming a filter membrane, to intercept an organic matter and a precipitate;
(c) adjusting a resulting filtrate to be acidic with a pH adjuster;
(d) feeding a resulting acidic filtrate into an electro-Fenton reaction device, and subjecting the resulting acidic filtrate to oxidation under an acidic environment therein, such that a chemical oxygen demand (COD) removal rate of the ROC is not less than 97%;
(e) subjecting a resulting effluent from the electro-Fenton reaction device to fine filtration with a polypropylene (PP) microporous filter, to obtain a fine filtrate; and
(f) introducing the fine filtrate into a bipolar membrane electrodialysis device, and performing the bipolar membrane electrodialysis, to generate an acid and an alkali under the action of an external electric field.

In some embodiments of the present disclosure, in step (a), the calcium-magnesium precipitant includes or consists of NaOH and Na₂CO₃, the NaOH is added in an amount of 0.1% to 2.0%, and the Na₂CO₃ is added in an amount of 0.2% to 0.6%; and after a precipitation is conducted for 20 min to 50 min, a resulting system is adjusted to a pH value of 11 to 12.

In some embodiments of the present disclosure, in step (b), the diatomaceous earth has a particle size of 6 μm to 25 μm and is added in an amount of 0.8 g/L to 1.0 g/L; the filter membrane is formed on a surface of a filter element by bridging after continuously cycling for 5 min to 10 min, and the ROC after removing hardness is introduced by switching a valve to continuously intercept the precipitate.

In some embodiments of the present disclosure, in step (c), the pH adjuster is derived from the acid and the alkali regenerated from the resource treatment of the ROC by the bipolar membrane electrodialysis, and a residence time in step (c) is in a range of 10 min to 20 min; and the resulting filtrate is adjusted to have a pH value of 2 to 4.

In some embodiments of the present disclosure, in step (d), the electro-Fenton reaction device has a voltage of 10 V to 30 V, a pH value of 2.5 to 3.5, and an electrolysis time of 20 min to 100 min.

In some embodiments of the present disclosure, in step (e), a microporous filter membrane in the PP microporous filter has a pore size of 0.2 μm to 1.0 μm.

In some embodiments of the present disclosure, in step (f), the bipolar membrane electrodialysis device has a flow rate controlled at 60 L/h to 240 L/h and a direct current (DC) voltage applied to each group of membranes at 1 V to 3 V.

In some embodiments of the present disclosure, the bipolar membrane electrodialysis is performed through the following steps
f1, adding the ROC with an initial mass concentration of 3.5% to 20% into a feed liquid storage tank of the bipolar membrane electrodialysis device, adding a Na₂SO₄ solution with an initial mass concentration of 1% to 3% into an electrode liquid storage tank, adding a sulfuric acid solution with an initial mass concentration of 1% to 5% into an acid storage tank, and adding a sodium hydroxide solution with an initial mass concentration of 1% to 5% to an alkali storage tank;
f2, increasing a water flow pressure of an ROC circulating water, an electrode liquid circulating water, an acid liquid circulating water, and an alkali liquid circulating water in a balanced manner to not more than 3.0 bar separately; and
f3, performing circulation for 10 min to 20 min at a constant voltage and a limited current of 10 A to 15 A.

On the other hand, the present disclosure further provides a system for resource treatment of an ROC by bipolar membrane electrodialysis applicable to the method as described above, including a hardness removal device, a diatomaceous earth filter, a pH adjusting tank, the electro-Fenton reaction device, the PP microporous filter, and the bipolar membrane electrodialysis device, all of which are sequentially communicated, wherein a water outlet pipe of the hardness removal device and a water outlet pipe of the pH adjusting tank each are in communication with the bipolar membrane electrodialysis device.

In some embodiments of the present disclosure, the bipolar membrane electrodialysis device adopts a bipolar membrane electrodialysis membrane stack having a “BP-A-C” configuration-based one-cavity and multi-chamber plate frame structure, and includes a salt chamber, an alkali chamber, an acid chamber, and an electrode chamber, wherein the salt chamber is communicated with the feed liquid storage tank, a liquid storage tank, and a dilute liquid storage tank, respectively; the alkali chamber is communicated with the alkali storage tank, a deionized water replenishing tank, and an alkali product storage tank, respectively; the acid chamber is communicated with the acid storage tank, the deionized water replenishing tank, and an acid product storage tank, respectively; and the electrode chamber communicates with the electrode liquid storage tank to form a circulation loop.

The ROC in the ROC storage tank passes through the hardness removal device to remove hardness, is filtered with the diatomaceous earth filter, adjusted to a suitable pH value in the pH adjusting tank, oxidized in the electro-Fenton reaction device, subjected to fine filtration through the PP microporous filter, and then electrolyzed by the bipolar membrane electrodialysis device to generate acid and alkali.

By means of the foregoing technical solution, embodiments of the present disclosure has the following advantageous effects:
1. In the present disclosure, chemical impurity removal is conducted to remove calcium, magnesium, silicon dioxide and various heavy metals in the ROC. Moreover, a synergistic effect is achieved when combined with the optimization of a reagent ratio, resulting in simple composition of subsequent substances, easy recovery, and gentle use conditions, thereby achieving desirable impurity removal effects.
2. The mixed acid and mixed alkali solutions produced after ROC treatment could be used to adjust the pH value and clean the membrane during the pretreatment, or be purified and concentrated for external sale. This process not only avoids the purchase and transportation of acids and alkalis, but also reduces operating costs.
3. In the present disclosure, the use of bipolar membrane electrodialysis in treating ROC has characteristics of a simple operation process, a flexible membrane stack assembly method, and no secondary pollution. Compared with traditional evaporation-crystallization technology, this process does not waste resources and reduces the high energy consumption caused by miscellaneous salt treatment, thereby achieving dual considerations of resources and economy and achieving zero emissions of ROC.
4. Through a “feed-discharge” mode, solution concentrations in the raw material chamber, the acid chamber, and alkali chamber are controlled to change a circulation ratio, thus adjusting the contents of acid and alkali products. A precise liquid circuit control system could realize the continuous output of acid and alkali products and the continuous treatment of ROC, and is conducive to industrial production.

### BRIEF DESCRIPTION OF THE DRAWINGS

The accompanying drawings described here are provided for further understanding of the present disclosure, constitute a part of this disclosure, but do not constitute inappropriate limitations to the present disclosure.

FIG. 1 shows a schematic structural diagram of a system for resource treatment of an ROC by bipolar membrane electrodialysis according to one embodiment of the present disclosure.

FIG. 2 shows a schematic structural diagram of a bipolar membrane electrodialysis device according to one embodiment of the present disclosure.

FIG. 3 shows a flowchart of a method for resource treatment of an ROC by bipolar membrane electrodialysis according to one embodiment of the present disclosure.

FIG. 4 shows a schematic diagram of the principle for acid and alkali production by bipolar membrane electrodialysis.

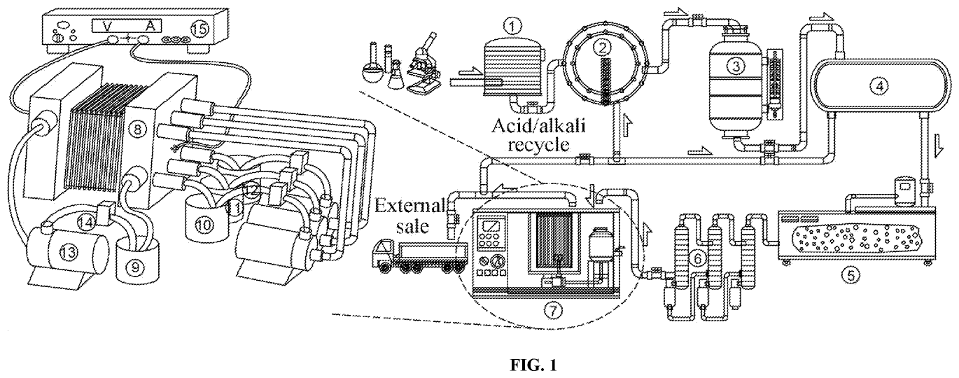

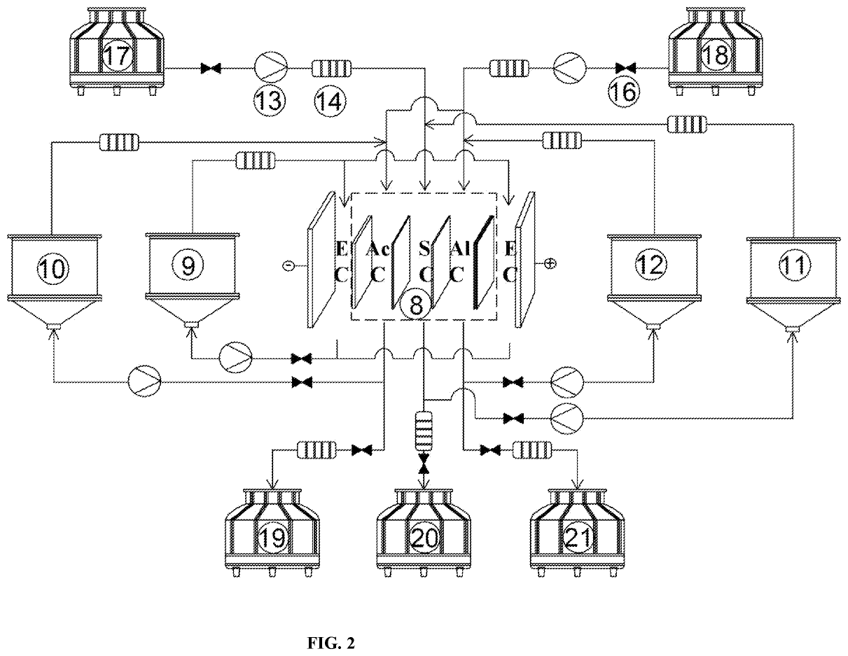

In FIG. 1 and FIG. 2, 1 represents ROC storage tank; 2 represents hardness removal device; 3 represents diatomaceous earth filter; 4 represents pH adjusting tank; 5 represents electro-Fenton reaction device; 6 represents PP microporous filter; 7 represents bipolar membrane electrodialysis device; 8 represents bipolar membrane electrodialysis membrane stack; 9 represents electrode liquid storage tank; 10 represents acid storage tank; 11 represents liquid storage tank; 12 represents alkali storage tank; 13 represents magnetic pump; 14 represents rotameter; 15 represents DC power supply; 16 represents valve; 17 represents feed liquid storage tank; 18 represents deionized water replenishing tank; 19 represents acid product storage tank; 20 represents dilute liquid storage tank; 21 represents alkali product storage tank; EC represents electrode chamber; SC represents salt chamber; AlC represents alkali chamber; and AcC represents acid chamber.

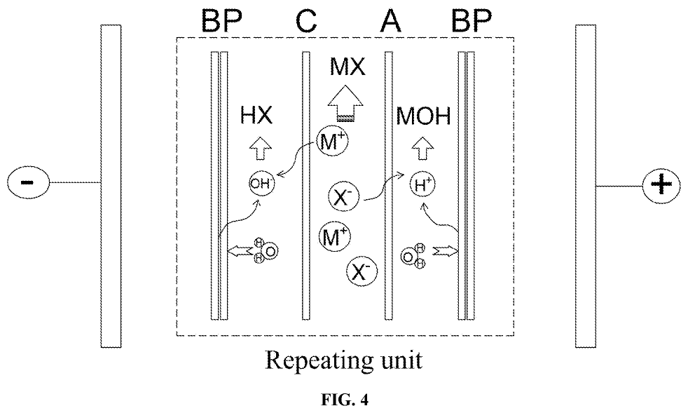

In FIG. 4, BP represents bipolar membrane; C represents cation exchange membrane; A represents anion exchange membrane; HX represents product acid; MOH represents product alkali; MX represents effluent after bipolar membrane electrodialysis treatment of ROC.

### DETAILED DESCRIPTION OF THE EMBODIMENTS

The present disclosure is described in detail below in conjunction with the accompanying drawings and specific examples. Exemplary examples and description of the present disclosure are intended to explain the present disclosure herein, but are not intended to limit the present disclosure.

As shown in FIG. 1, an embodiment of the present disclosure provides a system for resource treatment of an ROC by bipolar membrane electrodialysis applicable to the method as described above, including a hardness removal device 2, a diatomaceous earth filter 3, a pH adjusting tank 4, an electro-Fenton reaction device 5, a PP microporous filter 6, and a bipolar membrane electrodialysis device 7, all of which are sequentially communicated, wherein a water outlet pipe of the hardness removal device 2 and a water outlet pipe of the pH adjusting tank 4 each are in communication with the bipolar membrane electrodialysis device 7; and the product acid and alkali generated in the bipolar membrane electrodialysis device are recycled to the hardness removal device 2 and the pH adjusting tank 4.

The PP microporous filter 6 is made of polytetrafluoroethylene, and has a filter element length of 500 mm and a pore size of 0.22 μm.

The inert anode and cathode in an electrolytic cell of the electro-Fenton reaction device 5 each adopt a titanium electrode, a titanium alloy electrode, or a graphite electrode, and each have a flat, columnar, or porous configuration.

The ROC in the ROC storage tank 1 passes through the hardness removal device 2 to remove hardness, is filtered through the diatomaceous earth filter 3, adjusted to a suitable pH value in the pH adjusting tank 4, oxidized in the electro-Fenton reaction device 5, subjected to fine filtration with the PP microporous filter 6, and then electrolyzed in the bipolar membrane electrodialysis device 7 to generate acid and alkali.

An electrode liquid storage tank 9, an acid storage tank 10, a liquid storage tank 11, and an alkali storage tank 12 are in cyclic communication with the bipolar membrane electrodialysis membrane stack 8, and the bipolar membrane electrodialysis membrane stack 8 is connected to the DC power supply 15. An outlet side of the storage tank is connected to a magnetic pump 13, and an inlet side thereof is connected to the bipolar membrane electrodialysis membrane stack 8. An inlet side of the magnetic pump 13 is connected to the storage tank, and an outlet side thereof is connected to the bipolar membrane electrodialysis membrane stack 8, with a rotameter 14 and a valve 16 that are disposed therebetween. An inlet side of the bipolar membrane electrodialysis membrane stack 8 is connected to the magnetic pump 13; an outlet side thereof is connected to the storage tank, and an outlet end thereof is provided with a cooler to control a solution temperature. A distribution box is connected to the magnetic pump 13 and a DC power supply 15, and the DC power supply 15 is connected to positive and negative electrodes of the bipolar membrane electrodialysis membrane stack 8.

As shown in FIG. 2, an embodiment of the present disclosure provides a bipolar membrane electrodialysis device. The bipolar membrane electrodialysis device 7 has a “BP-A-C” configuration-based one-cavity and multi-chamber plate frame structure, and includes the bipolar membrane electrodialysis membrane stack 8, the bipolar membrane electrodialysis membrane stack 8 consisting of a bipolar membrane, a cation exchange membrane, an anion exchange membrane, an electrode plate (titanium matrix coated with ruthenium), and a compression device, wherein each membrane has an area of 110 mm×270 mm. There is an electrode liquid chamber on both sides of the bipolar membrane electrodialysis device (a left side is a cathode chamber and a right side is an anode chamber), which are connected to the positive and negative electrodes of the regulated DC power supply, respectively. The bipolar membrane, cation exchange membrane, and anion exchange membrane are alternately arranged between the anode chamber and the cathode chamber. The anion exchange membrane and the cation exchange membrane are spaced apart to form a salt chamber, the cation exchange membrane and the bipolar membrane are spaced apart to form an alkali chamber, and the anion exchange membrane and the bipolar membrane are spaced apart to form an acid chamber. The acid chamber, salt chamber, and alkali chamber constitute a repeating unit. The membranes in each chamber are separated by a deflector, with a flow rate controlled at 60 L/h to 240 L/h. A DC voltage applied to each group of membranes is in a range of 1 V to 3 V.

The bipolar membrane electrodialysis membrane stack 8 is in a “BP-A-C” configuration-based one-cavity and multi-chamber plate frame structure, and includes a salt chamber, an alkali chamber, an acid chamber, and an electrode chamber; the salt chamber is communicated with a feed liquid storage tank 17, a liquid storage tank 11, and a dilute liquid storage tank 21, respectively; the alkali chamber is communicated with an alkali storage tank 12, a deionized water replenishing tank 18, and an alkali product storage tank 21, respectively; the acid chamber is communicated with an acid storage tank 10, the deionized water replenishing tank 18, and an acid product storage tank 19, respectively; and the electrode chamber communicates with the electrode liquid storage tank 9 to form a circulation loop.

The feed liquid storage tank 17 and the deionized water replenishing tank 18 are connected to the salt chamber and the acid/alkali chambers of the bipolar membrane electrodialysis membrane stack 8, respectively, and the flow rate is controlled by the magnetic pump 13 and the rotameter 14 provided on a circulation pipeline. An acid chamber output liquid and an alkali chamber output liquid are communicated with the acid storage tank 10 and the alkali storage tank 12, respectively, and acid and alkali circulation loops are formed through circulation pipeline(s) and the bipolar membrane electrodialysis membrane stack 8, respectively. The electrode liquid storage tank 9 is communicated with the bipolar membrane electrodialysis membrane stack 8, thereby forming an electrode liquid circulation loop. A salt chamber output liquid is communicated with the liquid storage tank 11, and a feed liquid circulation loop is formed through circulation pipeline(s) and the bipolar membrane electrodialysis membrane stack 8. A product acid in the acid storage tank 10 and a product alkali in the alkali storage tank 12 are discharged to the acid product storage tank 19 and the alkali product storage tank 21 through the valve 16, respectively. A dilute liquid in the liquid storage tank 11 is discharged to the dilute liquid storage tank 20 through the valve.

The magnetic pump 13, valve 16, and rotameter 14 are provided on each circulation pipeline.

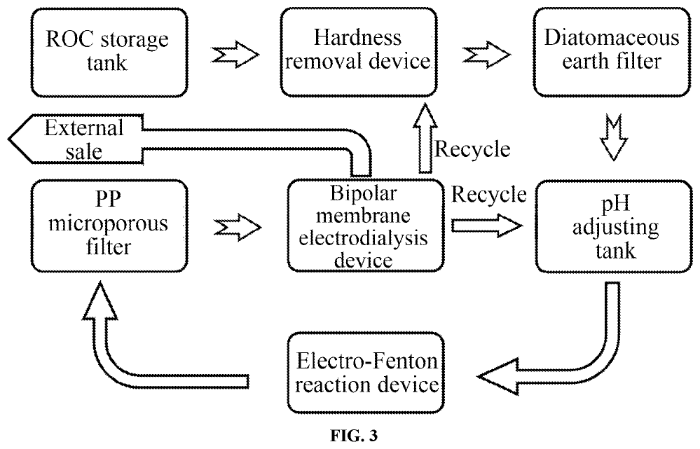

As shown in FIG. 3, an embodiment of the present disclosure provides a method for resource treatment of an ROC by bipolar membrane electrodialysis, including the following steps:

Step a: the ROC is introduced into the hardness removal device 2, and a reagent is added thereto, and a resulting mixture is mixed by stirring, in which the hardness removal device is a mixing reaction tank, NaOH and Na₂CO₃ are added thereto as the calcium-magnesium precipitant (i.e., the reagent), the NaOH is added in an amount of 0.1% to 2.0%, and the Na₂CO₃ is added in an amount of 0.2% to 0.6%; and a resulting system after removing hardness is adjusted to a pH value of 11 to 12 after the precipitation is conducted for 20 min to 50 min.

The reagent (i.e., the calcium-magnesium precipitant) fully reacts with ROC to form insoluble calcium carbonate and magnesium hydroxide precipitates to remove incompletely precipitated calcium and magnesium, thereby removing not less than 99% of hardness.

Step b: a resulting mixture after removing hardness in step a is filtered through the diatomaceous earth filter 3, which is realized by forming a filter membrane on a surface of diatomaceous earth, so as to intercept an organic matter and a precipitate.

The diatomaceous earth has a particle size of 6 μm to 25 μm, and the diatomaceous earth is added in an amount of 0.8 g/L to 1.0 g/L; a circulation pump is turned on to send the prepared slurry into the filter. Depending on the pressure of a water pump (working pressure at 0.3 MPa to 0.6 MPa), a part of the diatomaceous earth is retained by the filter element and adheres to its surface. Generally, after 5 min to 10 min of continuous circulation, bridges are formed on the surface of the filter element to form a filter membrane. The valve is switched to introduce the ROC after removing hardness, and the precipitate is continuously intercepted. When the pump has an outlet pressure of 0.65 MPa and a flow rate lower than 1.5 m³/h, the cycle ends to enter a backwashing stage.

Step c, a filtrate filtered through the diatomaceous earth filter 3 is introduced into the pH adjusting tank 4, and hydrochloric acid or sulfuric acid is added into the pH adjusting tank 4 to adjust the filtrate to be acidic.

The pH adjusting tank 4 is configured to continuously adjust and stabilize the pH value of the filtrate passing through the diatomaceous earth filter. A pH adjuster used is derived from the acid and the alkali regenerated from the resource treatment of the ROC by the bipolar membrane electrodialysis, and a residence time in the pH adjusting tank 4 is in a range of 10 min to 20 min; and the acidic filtrate after acid treatment in the pH adjusting tank 4 has an optimal pH value of 2 to 4.

Step d: the acidic filtrate treated in the pH adjusting tank enters the electro-Fenton reaction device 5, and in an acidic environment Fe²⁺ which is produced by the plate itself after energization reacts rapidly with H₂O₂ to generate highly active hydroxyl radicals (·OH), wherein the ·OH could continuously and effectively cause COD, ammonia nitrogen and other pollutants to directly lose their electrons and be oxidized, such that the COD removal rate is not less than 97%.

The inert anode and cathode of an electrolytic cell of the electro-Fenton reaction device 5 may be titanium electrode(s), titanium alloy electrode(s), or graphite electrode(s), and their configuration may be flat, columnar or porous. The electrolysis is conducted by a regulated DC power supply with a voltage of 10 V to 30 V at a pH value of 2.5 to 3.5 for 20 min to 100 min.

The electro-Fenton reaction device 5 is provided with two reaction zones, which are a reduction internal electrolysis reaction tank and a Fenton oxidation reaction tank. The reaction tanks are separately provided with a filler, and the device has a dimension: 1000×600×1800 (length×width×height, mm). The principle of device is to electrolyze the ROC entering the reduction internal electrolysis reaction tank under the condition of energization. The ROC has a residence time of 0.5 h to 1 h in the reduction internal electrolysis reaction tank, and has a residence time of 0.5 h to 2 h in the Fenton oxidation reaction tank. O₂ is reduced by electrons at the cathode to generate H₂O₂, and H₂O₂ further reacts rapidly with Fe² in the solution to generate active hydroxyl radicals (·OH). The active ·OH reacts with macromolecular organic matters in the Fenton oxidation reaction tank, thereby destroying a molecular structure of the organic matters, such that the refractory organic matters are converted into CO₂, H₂O, and small organic molecules to obtain degraded wastewater.

Step e: an effluent from the electro-Fenton reaction device 5 is subjected to fine filtration with the PP microporous filter 6, wherein a microporous filter membrane in the PP microporous filter 6 has a pore size of 0.2 μm to 1.0 μm, to obtain a treatment liquid that meets the requirements for entering the bipolar membrane electrodialysis modules.

Step f: the filtrate after fine filtration with the PP microporous filter 6 is introduced into the bipolar membrane electrodialysis device 7. Na⁺, K⁺, NH₄⁺, SO₄²⁻, Cl⁻, NO₃⁻ in the raw material chamber pass through the cation exchange membrane and anion exchange membrane to enter the alkali chamber and acid chamber under the action of an external electric field, respectively, and then combines with H⁺ and OH⁻ dissociated from the water by bipolar membrane to generate the acid and alkali.

The bipolar membrane electrodialysis device 7 is in a “BP-A-C” configuration-based one-cavity and multi-chamber plate frame structure, which consists of a membrane stack, a magnetic pump, a liquid storage tank, a distribution box, and a regulated DC power supply. The membrane stack is composed of an electrode region, an anion exchange membrane, a cation exchange membrane, a bipolar membrane, and a compression device. In the membrane stack, a number of membrane groups could be freely increased or decreased with the amount of solution to be treated, a flow rate is controlled at 60 L/h to 240 L/h, and a DC voltage applied to each group of membranes is in a range of 1 V to 3 V.

The electrode region adopts a ruthenium-coated titanium electrode, the anion and cation exchange membranes are both a perfluorosulfonic acid membrane (Nafion™), and the bipolar membrane is a BP-1 bipolar membrane. The bipolar membrane electrodialysis includes/consists of the following steps:
f1, adding the ROC with an initial mass concentration of 3.5% to 20% into a feed liquid storage tank of the bipolar membrane electrodialysis device, adding a Na₂SO₄ solution with an initial mass concentration of 1% to 3% into an electrode liquid storage tank, and adding a sulfuric acid solution with an initial mass concentration of 1% to 5% into an acid storage tank, and adding a sodium hydroxide solution with an initial mass concentration of 1% to 5% to an alkali storage tank.

In some embodiments, the ROC includes the following main anions: Cl⁻ (19.8 g/L), SO₄²⁻ (18.5 g/L), and NO₃⁻ (1.2 g/L), and the following main cations: Na⁺ (23.2 g/L), NH₄⁺ (3.9 g/L), Ca²⁺ (2.7 g/L), Mg²⁺ (1.4 g/L), and K⁺ (0.8 g/L).
f2, while turning on the pump, slowly opening valves of an acid chamber circulating water, an alkali chamber circulating water, and an electrode water, such that a water flow pressure of the three-way water flow increases in a balanced manner, wherein all pipeline connections must be arranged in a “bottom inlet and top outlet” manner; a pressure generated by the water flow is not more than 3.0 bar, and the electrode liquid flows into the cathode chamber and anode chamber in sequence, and enters a closed circuit circulation;
f3, running on the closed circuit circulation for 10 min to 20 min; after a flow rate of each water flow in the device reaches balance and stability, removing air bubbles in the membrane stack, turning on the DC power supply and operating in a constant-voltage and limited-current mode, wherein the current is limited to 10 A to 15 A, and a required current is preset (the current is generally in a range of 0 A to 10 A determined by a current density);

f4, under the action of a DC electric field, dissociating H₂O in an interface layer of the bipolar membrane into H⁺ and OH⁻ which migrate to the acid chamber and alkali chamber, respectively, where the H⁺ and negatively-charged salt ions passing through the anion exchange membranes form mixed acid in the acid chamber; and OH⁻ and positively-charged salt ions passing through the cation exchange membranes form mixed alkali in the alkali chamber; and

f5, by setting the salt chamber, acid chamber, and alkali chamber in a “continuous operation” mode, controlling inlet and outlet flow rates of the acid chamber, alkali chamber, and salt chamber, as well as a circulation flow rate of the solution in each chamber in the membrane stack; wherein under the condition that an acid/alkali concentration reaches a certain value, the prepared acid/alkali is continuously pumped into the acid/alkali storage tank, while deionized water is also continuously pumped into a bipolar membrane electrodialysis (BMED) membrane stack; under the condition that a concentration of the feed liquid drops to a certain value, a new feed liquid is introduced immediately for replacement to ensure the continuous preparation of acid and alkali.

A principle of an embodiment of the present disclosure is shown in FIG. 4. The membrane stack of this configuration mainly includes an anion exchange membrane (AEM), a cation exchange membrane (CEM), and a bipolar membrane (BPM), all of which are arranged alternately. Under the action of the DC power supply, between the cation exchange membrane C and anion exchange membrane A, an electrolyte solution (MX) added to the salt chamber begins to decompose into anions (X⁻) and cations (M⁺). The X⁻ further passes through the AEM and generates the product acid HX with H⁺ dissociated from the BPM, while M⁺ further passes through the CEM and generates the product alkali MOH with OH⁻ dissociated from the BPM. After a certain period of treatment, desalination could be achieved, and an effluent MX from resource treatment of the ROC by bipolar membrane electrodialysis is discharged, and the obtained product acid and alkali could be reused.

The present disclosure is further described below in conjunction with different examples.

### Example 1

ROC had a water quality shown in Table 1 and was treated through the following steps.

(1) The ROC was introduced into a hardness removal device 2, and a softening agent was added, wherein the softening agent consisted of 0.2% NaOH and 0.3% Na₂CO₃, and the NaOH and Na₂CO₃ were added gradually with stirring. The stirring was conducted at 100 r/min for 1 h. After leaving to stand, a resulting mixture was filtered and the precipitate was filtered out, and a pH value of a resulting filtrate was adjusted to 11 to 12 to remove incompletely precipitated calcium and magnesium, thus realizing a hardness removal rate of not less than 99%. The agent reacted fully with ROC to form insoluble calcium carbonate and magnesium hydroxide precipitates. The water quality indicators of an effluent obtained from the hardness removal unit were shown in Table 2.

(2) The effluent from step (1) was introduced into a diatomaceous earth filter 3, and a prepared 0.9 g/L diatomaceous earth slurry was added into the filter through a circulating pump; relying on a 0.6 MPa pressure of the circulation pump, a part of the diatomaceous earth could bridge on a surface of the filter to form a filter membrane, generally by 8 min of continuous circulation; and a valve was switched to introduce the ROC after hardness removal, such that the precipitate and some organic matters were continuously intercepted. The water quality indicators of an effluent from the primary filtration unit were shown in Table 2.

(3) The filtrate obtained in step (2) was introduced into a pH adjusting tank 4 with a residence time of 10 min; and hydrochloric acid or sulfuric acid was added thereto to adjust the filtrate to be acidic, with a pH value of 4. The water quality indicators of an effluent from the pH adjusting unit were shown in Table 2.

(4) The acidic filtrate obtained in step (3) was pumped into an electro-Fenton reaction device 5, and the ROC in a reduction internal electrolysis reaction tank was subjected to electrolysis under the condition of energization at a voltage of 15 V with a pH value of 3.5 for 80 min. O₂ was reduced by electrons at the cathode to generate H₂O₂, and the H₂O₂ further reacted rapidly with Fe²⁺ in the solution to generate active hydroxyl radicals (·OH). The active ·OH reacted with macromolecular organic matters in the Fenton oxidation reaction tank, thereby destroying a molecular structure of the organic matters, such that the refractory organic matters were converted into CO₂, H₂O, and small organic molecules, thereby reducing the COD to not more than 40 mg/L. The water quality indicators of an effluent from the electro-Fenton unit were shown in Table 2.

(5) The effluent obtained in step (4) was then subjected to fine filtration with a PP microporous filter 6 to obtain a treatment liquid that met the requirements for entering the bipolar membrane electrodialysis modules. The water quality indicators of an effluent passing through the microporous fine filtration unit were shown in Table 2.

(6) The effluent obtained in step (5) was introduced into a salt chamber of a bipolar membrane electrodialysis membrane stack 8, wherein a feed liquid chamber, an acid chamber, and an alkali chamber adopted the “intermittent” operation mode, as shown in FIG. 1. In this mode, the acid, alkali, and ROC circulated continuously in the membrane stack until the salt chamber completed desalination. A valve was opened to allow the filtrate after the fine filtration to enter the feed liquid chamber. When a liquid level reached a certain height, the pump was started for continuous ten minutes. When the pressure was stable, the flow rate reached 100 L/h, and there were no air bubbles in the pipeline, the DC power supply was turned on and set to a voltage of 24 V. Na⁺, K⁺, NH₄⁺, SO₄²⁻, Cl⁻, and NO₃⁻ in the feed liquid chamber passed through the cation exchange membrane and anion exchange membrane to enter the alkali chamber and acid chamber under voltage drive, respectively, and then combined with the OH⁻ and H⁺ dissociated from the water by bipolar membrane to generate alkalis and acids, respectively. When a conductivity in the salt chamber dropped to 100 μS/cm, the DC power supply was turned off, the acid and alkali were discharged, deionized water was added, and a valve of the PP microporous filter 6 was opened to send the ROC into the feed liquid chamber to start the next batch of treatment, and the collected acid and alkali were reused in a pretreatment system or purified and concentrated for external sale. If it was necessary to stop operation, deionized water was added for circulation cleaning. The pump could be turned off only when the feed liquid and effluent has a same conductivity. The water quality indicators of an effluent from the bipolar membrane electrodialysis unit were shown in Table 2.

TABLE 1
Water quality indicators of ROC

| | Water quality indicators | Example 1 | Example 2 | Example 3 |
|---|---|---|---|---|
| SN | of ROC | Value (mg/L) | | |
| 1 | COD(mg/L) | 1526.48 | 2022.59 | 3816.2 |
| 2 | Alkalinity (mg/L) | 2531.44 | 3354.12 | 6328.6 |
| 3 | Total water hardness | 6101.68 | 8084.73 | 15254.2 |
| | (mg/L) | | | |
| 4 | DOC(mg/L) | 164.8 | 218.36 | 412 |
| 5 | pH | 6.96 | 7.47 | 8.26 |
| 6 | Chromaticity (times) | 6736 | 8925.2 | 16840 |
| 7 | TDS(mg/L) | 43280 | 57346 | 108200 |
| 8 | Cl⁻(mg/L) | 19890.6 | 26355.05 | 49726.5 |
| 9 | SO₄²⁻(mg/L) | 18524.88 | 24545.47 | 46312.2 |
| 10 | Ca²⁺(mg/L) | 2710.92 | 3591.97 | 6777.3 |
| 11 | Mg²⁺(mg/L) | 1438 | 1905.35 | 3595 |
| 12 | K⁺(mg/L) | 834.28 | 1105.42 | 2085.7 |
| 13 | Na⁺(mg/L) | 23154.52 | 30679.74 | 57886.3 |
| 14 | NH₄⁺(mg/L) | 3868.68 | 5126.00 | 9671.7 |
| 15 | NO₃⁻(mg/L) | 1233.8 | 1634.79 | 3084.5 |

TABLE 2
Water quality indicators of ROC after treatment in each unit in Example 1

| | Treatment unit | | | | |
|---|---|---|---|---|---|
| | | | | | Bipolar |
| | Hardness | | pH | Electro-Fenton | membrane |
| | removal | Diatomaceous | adjusting | reaction | electrodialysis |
| Item | device | earth filter | tank | device | device |
| COD(mg/L) | 1352.81 | 1339.28 | 1312.49 | 33.74 | 1.01 |
| Alkalinity (mg/L) | 2711.62 | 2684.50 | 30.81 | 24.96 | 0.74 |
| Total water | 81.34 | 80.52 | 78.90 | 74.16 | 2.22 |
| hardness (mg/L) | | | | | |
| DOC(mg/L) | 157.6 | 132.02 | 129.37 | 1.60 | 0 |
| pH | 10.59 | 9.88 | 2.33 | 2.19 | 6.37 |
| Chromaticity | 4652 | 3956 | 2876 | 44 | 1 |
| (dilution times) | | | | | |
| TDS(mg/L) | 34226 | 33883.74 | 33206.06 | 30213.6 | 906.40 |
| Cl⁻(mg/L) | 19293.88 | 19100.94 | 18718.92 | 17595.78 | 527.87 |
| SO₄²⁻(mg/L) | 17969.13 | 17789.43 | 17433.64 | 16387.62 | 491.62 |
| Ca²⁺(mg/L) | 1.8 | 1.78 | 1.74 | 0.63 | 0 |
| Mg²⁺(mg/L) | 0.00 | 0.00 | 0.00 | 0.00 | 0.00 |
| K⁺(mg/L) | 809.25 | 801.15 | 785.12 | 738.01 | 0.14 |
| Na⁺(mg/L) | 22459.88 | 22235.28 | 21790.57 | 20483.13 | 614.49 |
| NH₄⁺(mg/L) | 3152.61 | 3121.08 | 3058.65 | 2875.13 | 6.25 |
| NO₃⁻(mg/L) | 1196.78 | 1184.81 | 1161.11 | 1091.44 | 32.74 |

The acid concentration of the acid product was 0.79 mol/L, the alkali concentration of the alkali product was 0.74 mol/L, the average current efficiency was 77%, the energy consumption was 2.2 kwh/kg sodium hydroxide, and the desalination rate of ROC was 97.61%.

### Example 2

ROC had a water quality shown in Table 1 and was treated through the following steps:
(1) The ROC was introduced into a hardness removal device 2, and a softening agent was added, wherein the softening agent consisted of 0.1% sodium hydroxide and 0.6% sodium carbonate, and the sodium hydroxide and sodium carbonate were added gradually with stirring. The stirring was conducted at 100 r/min for 1 h. After leaving to stand, a resulting mixture was filtered and the precipitate was filtered out, and a pH value of a resulting filtrate was adjusted to 11 to 12 to remove incompletely precipitated calcium and magnesium, thus realizing a hardness removal rate of not less than 99%. The agent reacted fully with ROC to form insoluble calcium carbonate and magnesium hydroxide precipitates. The water quality indicators of an effluent obtained from the hardness removal unit were shown in Table 3.
(2) The effluent from step (1) was introduced into a diatomaceous earth filter 3, and a prepared 0.9 g/L diatomaceous earth slurry was added into the filter through a circulating pump; relying on a 0.6 MPa pressure of the circulation pump, a part of the diatomaceous earth could bridge on a surface of the filter to form a filter membrane, generally by 10 min of continuous circulation; and a valve was switched to introduce the ROC after calcium-magnesium removal, such that the precipitate and some organic matters were continuously intercepted. The water quality indicators of an effluent from the primary filtration unit were shown in Table 3.
(3) The filtrate obtained in step (2) was introduced into a pH adjusting tank 4 with a residence time of 10 min; and hydrochloric acid or sulfuric acid was added thereto to adjust the filtrate to be acidic, with a pH value of 2 to 4. The water quality indicators of an effluent from the pH adjusting unit were shown in Table 3.
(4) The acidic filtrate in step (3) was pumped into an electro-Fenton reaction device 5, and the ROC in a reduction internal electrolysis reaction tank was subjected to electrolysis under the condition of energization at a voltage of 30 V with a pH value of 3.5 for 80 min. O₂ was reduced by electrons at the cathode to generate H₂O₂, and the H₂O₂ further reacted rapidly with Fe²⁺ in the solution to generate active hydroxyl radicals (·OH). The active ·OH reacted with macromolecular organic matters in the Fenton oxidation reaction tank, thereby destroying a molecular structure of the organic matters, such that the refractory organic matters were converted into CO₂, H₂O, and small organic molecules, thereby reducing the COD to not more than 50 mg/L. The water quality indicators of an effluent from the electro-Fenton unit were shown in Table 3.
(5) The effluent obtained in step (4) was subjected to fine filtration with a PP microporous filter 6 to obtain a treatment liquid that met the requirements for entering the bipolar membrane electrodialysis modules. The water quality indicators of an effluent passing through the microporous fine filtration unit were shown in Table 3.
(6) The effluent from step (5) was introduced into a salt chamber of a bipolar membrane electrodialysis membrane stack 8. The salt chamber, acid chamber, and alkali chamber adopted a “feed-discharge” operation mode. There were 15 groups of membranes, and 0.1 mol/L acid/alkali (in a same volume) was added into the acid/alkali chamber. In this mode, the acid, alkali, salt, and electrode solution still circulated according to the process shown in FIG. 1, except that all valves were opened and all delivery pumps were turned on. Most of the acid, alkali, and salt solutions were circulated in the system, while small parts thereof continuously flowed out of the system and were pumped into the corresponding storage tanks. Meanwhile, deionized water or concentrated feed liquid was replenished, thereby achieving the continuous output of acid and alkali products and continuous treatment of ROC. When the ROC entering the feed liquid chamber reached a set liquid level, the feeding was stopped, and the pump was started and operated continuously for ten minutes. When the pressure was stable, the flow rate reached 100 L/h, and there were no air bubbles in the pipeline, the DC power supply was turned on and set to a voltage of 36 V. Na⁺, K⁺, NH₄⁺, SO₄²⁻, Cl⁻, and NO₃⁻ in the feed liquid chamber passed through the cation exchange membrane and anion exchange membrane to enter the alkali chamber and acid chamber under voltage drive, respectively, and then combined with the OH⁻ and H⁺ dissociated from the water by bipolar membrane to generate alkalis and acids, respectively. The collected acids and alkalis were reused in a pretreatment system or purified and concentrated for external sale. If it was necessary to stop operation, deionized water was added for circulation cleaning. The pump could be turned off only when the feed liquid and effluent have a same conductivity. The water quality indicators of an effluent from the bipolar membrane electrodialysis unit were shown in Table 3.

TABLE 3
Water quality indicators of ROC after treatment in each unit in Example 2

| | Treatment unit | | | | |
|---|---|---|---|---|---|
| | | | | | Bipolar |
| | | | pH | Electro-Fenton | membrane |
| | Hardness | Diatomaceous | adjusting | reaction | electrodialysis |
| Item | removal device | earth filter | tank | device | device |
| COD(mg/L) | 1792.47 | 1774.55 | 1739.05 | 44.71 | 1.34 |
| Alkalinity | 3592.90 | 3556.96 | 40.82 | 33.07 | 0.98 |
| (mg/L) | | | | | |
| Total water | 107.78 | 106.69 | 104.54 | 98.26 | 2.94 |
| hardness (mg/L) | | | | | |
| DOC(mg/L) | 208.82 | 174.93 | 171.42 | 2.12 | 0.00 |
| pH | 11.37 | 10.60 | 2.50 | 2.35 | 6.84 |
| Chromaticity | 6163.90 | 5241.70 | 3810.70 | 58.30 | 1.33 |
| (dilution times) | | | | | |
| TDS(mg/L) | 45349.45 | 44895.96 | 43998.03 | 40033.02 | 1200.98 |
| Cl⁻(mg/L) | 25564.39 | 25308.75 | 24802.57 | 23314.41 | 2216.67 |
| SO₄²⁻(mg/L) | 23809.10 | 23570.99 | 23099.57 | 21713.60 | 2064.45 |
| Ca²⁺(mg/L) | 2.39 | 2.36 | 2.31 | 0.83 | 0.00 |
| Mg²⁺(mg/L) | 2.65 | 1.11 | 0.24 | 0.00 | 0.00 |
| K⁺(mg/L) | 1072.26 | 1061.52 | 1040.28 | 977.86 | 0.60 |
| Na⁺(mg/L) | 29759.34 | 29461.75 | 28872.51 | 27140.15 | 2580.40 |
| NH₄⁺(mg/L) | 4177.21 | 4135.43 | 4052.71 | 3809.55 | 26.24 |
| NO₃⁻(mg/L) | 1585.73 | 1569.87 | 1538.47 | 1446.16 | 137.48 |

The acid concentration of the acid product was 1.24 mol/L, the alkali concentration of the alkali product was 1.18 mol/L, the average current efficiency was 72%, the energy consumption was 2.8 kwh/kg sodium hydroxide, and the desalination rate of ROC was 92.6%.

### Example 3

ROC had a water quality shown in Table 1 and was treated through the following steps:
(1) The ROC was introduced into a hardness removal device 2, and a softening agent was added, wherein the softening agent consisted of 1.5% NaOH and 0.2% Na₂CO₃, and the NaOH and Na₂CO₃ were added gradually with stirring. The stirring was conducted at 100 r/min for 1 h. A resulting mixture was left to stand for 50 min, and a pH value of a resulting system was adjusted to 11 to 12 to remove incompletely precipitated calcium and magnesium, thus realizing a hardness removal rate of not less than 99%. The agent reacted fully with ROC to form insoluble calcium carbonate and magnesium hydroxide precipitates. The water quality indicators of an effluent obtained from the hardness removal unit were shown in Table 4.
(2) The effluent from step (1) was introduced into a diatomaceous earth filter 3, and a prepared 0.9 g/L diatomaceous earth slurry was added into the filter through a circulating pump; relying on a 0.6 MPa pressure of the circulation pump, a part of the diatomaceous earth could bridge on a surface of the filter to form a filter membrane, generally by 5 min of continuous circulation; and a valve was switched to introduce the ROC after hardness removal, such that the precipitate and some organic matters were continuously intercepted. The water quality indicators of an effluent from the primary filtration unit were shown in Table 4.
(3) The filtrate obtained in step (2) was introduced into a pH adjusting tank 4 with a residence time of 10 min; and hydrochloric acid or sulfuric acid was added thereto to adjust the filtrate to be acidic, with a pH value of 2 to 4. The water quality indicators of an effluent from the pH adjusting unit were shown in Table 4.
(4) The acidic filtrate obtained in step (3) was pumped into an electro-Fenton reaction device 5, and the ROC in a reduction internal electrolysis reaction tank was subjected to electrolysis under the condition of energization at a voltage of 10 V with a pH value of 3.5 for 80 min. O₂ was reduced by electrons at the cathode to generate H₂O₂, and the H₂O₂ further reacted rapidly with Fe²⁺ in the solution to generate active hydroxyl radicals (·H). The active ·OH reacted with macromolecular organic matters in the Fenton oxidation reaction tank, thereby destroying a molecular structure of the organic matters, such that the refractory organic matters were converted into CO₂, H₂O, and small organic molecules, thereby reducing the COD to not more than 90 mg/L. The water quality indicators of an effluent from the electro-Fenton unit were shown in Table 4.
(5) The effluent obtained in step (4) was then subjected to fine filtration with a PP microporous filter 6 to obtain a treatment liquid that met the requirements for entering the bipolar membrane electrodialysis modules. The water quality indicators of an effluent passing through the microporous fine filtration unit were shown in Table 4.
(6) The effluent from step (5) was introduced into a salt chamber of a bipolar membrane electrodialysis membrane stack 8. The salt chamber, acid chamber, and alkali chamber adopted a “feed-discharge” operation mode. There were 20 groups of membranes, and 0.1 mol/L acid/alkali (in a same volume) was added into the acid/alkali chamber. In this mode, the acid, alkali, salt, and electrode solution still circulated according to the process shown in FIG. 1, except that all valves were opened and all delivery pumps were turned on. Most of the acid, alkali, and salt solutions were circulated in the system, while small parts thereof continuously flowed out of the system and were pumped into the corresponding storage tanks. Meanwhile, deionized water or concentrated feed liquid was replenished, thereby achieving the continuous output of acid and alkali products and continuous treatment of ROC. When the ROC entering the feed liquid chamber reached a set liquid level, the feeding was stopped, and the pump was started and operated continuously for ten minutes. When the pressure was stable, the flow rate reached 120 L/h, and there were no air bubbles in the pipeline, the DC power supply was turned on and set to a voltage of 48 V. Na⁺, K⁺, NH₄⁺, SO₄²⁻, Cl⁻, and NO₃⁻ in the feed liquid chamber passed through the cation exchange membrane and anion exchange membrane to enter the alkali chamber and acid chamber under voltage drive, respectively, and then combined with OH⁻ and H⁺ dissociated from the water by bipolar membrane to generate alkalis and acids, respectively. The collected acids and alkalis were reused in a pretreatment system or purified and concentrated for external sale. If it was necessary to stop operation, deionized water was added for circulation cleaning. The pump could be turned off only when the feed liquid and effluent have a same conductivity. The water quality indicators of an effluent from the bipolar membrane electrodialysis unit were shown in Table 4.

TABLE 4
Water quality indicators of ROC after treatment in each unit in Example 3

| | Treatment unit | | | | |
|---|---|---|---|---|---|
| | | | | | Bipolar |
| | Hardness | | pH | Electro-Fenton | membrane |
| | removal | Diatomaceous | adjusting | reaction | electrodialysis |
| Item | device | earth filter | tank | device | device |
| COD(mg/L) | 3348.21 | 3314.72 | 3248.42 | 83.51 | 2.50 |
| Alkalinity | 6711.26 | 6644.14 | 76.26 | 61.78 | 1.83 |
| (mg/L) | | | | | |
| Total water | 201.32 | 199.29 | 195.28 | 183.55 | 5.49 |
| hardness | | | | | |
| (mg/L) | | | | | |
| DOC(mg/L) | 390.06 | 326.75 | 320.20 | 3.96 | 0.00 |
| pH | 12.44 | 11.61 | 2.74 | 2.57 | 6.49 |
| Chromaticity | 11513.70 | 9791.10 | 7118.10 | 108.90 | 2.48 |
| (dilution | | | | | |
| times) | | | | | |
| TDS(mg/L) | 84709.35 | 83862.26 | 82185.00 | 74778.66 | 2243.34 |
| Cl⁻(mg/L) | 47752.35 | 47274.83 | 46329.33 | 43549.56 | 10455.96 |
| SO₄²⁻(mg/L) | 44473.60 | 44028.84 | 43148.26 | 40559.36 | 9737.92 |
| Ca²⁺(mg/L) | 4.46 | 4.41 | 4.31 | 1.56 | 0.00 |
| Mg²⁺(mg/L) | 6.87 | 3.62 | 2.36 | 1.24 | 0.00 |
| K⁺(mg/L) | 2002.90 | 1982.85 | 1943.17 | 1826.58 | 2.80 |
| Na⁺(mg/L) | 55588.20 | 55032.32 | 53931.67 | 50695.75 | 12171.76 |
| NH₄⁺(mg/L) | 7802.71 | 7724.67 | 7570.16 | 7115.95 | 123.81 |
| NO₃⁻(mg/L) | 2962.03 | 2932.41 | 2873.75 | 2701.31 | 648.50 |

The acid concentration of the acid product was 2.1 mol/L, the alkali concentration of the alkali product was 1.96 mol/L, the average current efficiency was 61%, the energy consumption was 4.5 kwh/kg sodium hydroxide, and the desalination rate of ROC was 81.5%.

It can be seen from the above examples that the ROC could be treated by the method of the present disclosure, and the treated ROC has a COD≤3%, a content of calcium and magnesium ions ≤1%, and a salt content ≤1.3%. In view of the problems of traditional technology in treating ROC such as long process flow, great technical difficulty, complex treatment system, and high energy consumption cost, the present disclosure proposes to directly convert most of the ROC into acid and alkali by bipolar membrane electrodialysis without evaporation and crystallization, thus greatly reducing evaporation. Moreover, the bipolar membrane electrodialysis device has low space requirements and compact equipment, and could create certain economic benefits while reducing environmental harm. In addition, the excellent characteristics and economic advantages of BMED may provide new strategies for building desirable desalination systems, which may be an inevitable requirement and an important development direction for efficient utilization of water resources. Therefore, the method of the present disclosure is an effective solution with sustainable resource recycling, low energy consumption cost, and environmental friendliness.

The present disclosure is not limited to the foregoing examples. On the basis of the technical solution disclosed in the present disclosure, a person skilled in the art could make some substitutions and transformations for some of the technical features according to the technical disclosure without involving an inventive effort, and such substitutions and transformations fall within the scope of the present disclosure.

What is claims is:

1. A method for resource treatment of a reverse osmosis concentrated brine (ROC) by bipolar membrane electrodialysis, comprising the steps of
(a) adding a calcium-magnesium precipitant to the ROC, and mixing, to remove hardness;
(b) filtering a resulting mixture after removing hardness through diatomaceous earth, which is realized by forming a filter membrane, to intercept an organic matter and a precipitate;
(c) adjusting a resulting filtrate to be acidic with a pH adjuster;
(d) feeding a resulting acidic filtrate into an electro-Fenton reaction device, and subjecting the resulting acidic filtrate to oxidation under an acidic environment therein, such that a chemical oxygen demand removal rate of the ROC is not less than 97%;
(e) subjecting a resulting effluent from the electro-Fenton reaction device to fine filtration with a polypropylene (PP) microporous filter, to obtain a fine filtrate; and
(f) introducing the fine filtrate into a bipolar membrane electrodialysis device, and performing the bipolar membrane electrodialysis, to generate an acid and an alkali under the action of an external electric field.

2. The method as claimed in claim 1, wherein in step (a), the calcium-magnesium precipitant comprises NaOH and Na₂CO₃, the NaOH is added in an amount of 0.1% to 2.0%, and the Na₂CO₃ is added in an amount of 0.2% to 0.6%; and
after a precipitation is conducted for 20 min to 50 min, a resulting system is adjusted to a pH value of 11 to 12.

3. The method as claimed in claim 1, wherein in step (b), the diatomaceous earth has a particle size of 6 μm to 25 μm and is added in an amount of 0.8 g/L to 1.0 g/L; and
the filter membrane is formed on a surface of a filter element by bridging after continuously cycling for 5 min to 10 min, and the ROC after removing hardness is introduced by switching a valve to continuously intercept the precipitate.

4. The method as claimed in claim 1, wherein in step (c), the pH adjuster is derived from the acid and the alkali regenerated from the resource treatment of the ROC by the bipolar membrane electrodialysis, and a residence time is in a range of 10 min to 20 min; and
the resulting filtrate is adjusted to have a pH value of 2 to 4.

5. The method as claimed in claim 1, wherein in step (d), the electro-Fenton reaction device has a voltage of 10 V to 30 V, a pH value of 2.5 to 3.5, and an electrolysis time of 20 min to 100 min.

6. The method as claimed in claim 1, wherein in step (e), a microporous filter membrane in the PP microporous filter has a pore size of 0.2 μm to 1.0 μm.

7. The method as claimed in claim 1, wherein in step (f), the bipolar membrane electrodialysis device has a flow rate controlled at 60 L/h to 240 L/h and a direct current voltage applied to each group of membranes at 1 V to 3 V.

8. The method as claimed in claim 7, wherein the bipolar membrane electrodialysis is performed by the steps of
f1, adding the ROC with an initial mass concentration of 3.5% to 20% into a feed liquid storage tank of the bipolar membrane electrodialysis device, adding a Na₂SO₄ solution with an initial mass concentration of 1% to 3% into an electrode liquid storage tank, adding a sulfuric acid solution with an initial mass concentration of 1% to 5% into an acid storage tank, and adding a sodium hydroxide solution with an initial mass concentration of 1% to 5% to an alkali storage tank;
f2, increasing a water flow pressure of an ROC circulating water, an electrode liquid circulating water, an acid liquid circulating water, and an alkali liquid circulating water in a balanced manner to not more than 3.0 bar separately; and
f3, performing circulation for 10 min to 20 min at a constant voltage and a limited current of 10 A to 15 A.

9. A system for resource treatment of an ROC by bipolar membrane electrodialysis applicable to the method as claimed in claim 1, comprising a hardness removal device, a diatomaceous earth filter, a pH adjusting tank, the electro-Fenton reaction device, the PP microporous filter, and the bipolar membrane electrodialysis device, all of which are sequentially communicated,
wherein a water outlet pipe of the hardness removal device and a water outlet pipe of the pH adjusting tank each are in communication with the bipolar membrane electrodialysis device.

10. The system as claimed in claim 9, wherein the bipolar membrane electrodialysis device adopts a bipolar membrane electrodialysis membrane stack having a “BP-A-C” configuration-based one-cavity and multi-chamber plate frame structure, and comprises a salt chamber, an alkali chamber, an acid chamber, and an electrode chamber, wherein
the salt chamber is communicated with the feed liquid storage tank, a liquid storage tank, and a dilute liquid storage tank, respectively; the alkali chamber is communicated with the alkali storage tank, a deionized water replenishing tank, and an alkali product storage tank, respectively; the acid chamber is communicated with the acid storage tank, the deionized water replenishing tank, and an acid product storage tank, respectively; and the electrode chamber communicates with the electrode liquid storage tank to form a circulation loop.
